(19) United States
(12) Patent Application Publication
(10) Pub. No.: US 2018/0111504 A1
(43) Pub. Date: Apr. 26, 2018

(54) MONITORING DEVICE OF FUEL CELL, CONTROL DEVICE OF FUEL CELL, AND MONITORING METHOD OF FUEL CELL

(71) Applicant: TOYOTA JIDOSHA KABUSHIKI KAISHA, Toyota-shi (JP)

(72) Inventors: Masaaki MATSUSUE, Mishima-shi (JP); Yasushi ARAKI, Gotenba-shi (JP); Masayuki ITO, Sunto-gun (JP)

(73) Assignee: TOYOTA JIDOSHA KABUSHIKI KAISHA, Toyota-shi (JP)

(21) Appl. No.: 15/722,813

(22) Filed: Oct. 2, 2017

(30) Foreign Application Priority Data
Oct. 21, 2016 (JP) 2016-207059

(51) Int. Cl. B60L 11/18; B60H 1/00; H01M 8/04007; H01M 8/04992; H01M 8/04701

(52) U.S. Cl. CPC B60L 11/1892; B60H 1/00385; H01M 8/04067; H01M 8/04992; H01M 2250/20; B60H 1/00921; B60Y 2200/91; B60Y 2400/202; B60Y 2306/05; H01M 8/04701

(57) ABSTRACT

A monitoring device of a fuel cell includes: an acquisition unit configured to acquire a predicted vehicle speed at each point on a scheduled traveling route of a vehicle which travels using the fuel cell, a temperature of a refrigerant that receives heat from the fuel cell, and a temperature of air outside the vehicle to which the refrigerant exposed to a traveling airflow radiates heat; and a calculation unit configured to calculate a predicted temperature of the refrigerant at a first point on the scheduled traveling route based on the predicted vehicle speed at the first point, the temperature of the refrigerant, and the temperature of the outside air and to calculate the predicted temperature at a second point on the scheduled traveling route based on the predicted vehicle speed at the second point, the predicted temperature at the first point, and the temperature of the outside air.

### INCORPORATION BY REFERENCE

The disclosure of Japanese Patent Application No. 2016-207059 filed on Oct. 21, 2016 including the specification, drawings and abstract is incorporated herein by reference in its entirety.

### BACKGROUND

### 1. Technical Field

The present disclosure relates to a monitoring device of a fuel cell, a control device of a fuel cell, and a monitoring method of a fuel cell.

### 2. Description of Related Art

Use of a fuel cell as a power source of a vehicle is known. An amount of heat emitted from a fuel cell increases as an amount of power generated in the fuel cell increases, but the temperature of the fuel cell is controlled to be a desired temperature by keeping the temperature of a refrigerant for cooling the fuel cell at a target temperature. Here, when the temperature of the refrigerant departs from the target temperature, various processes may be performed. For example, in Japanese Patent Application Publication No. 2015-210908 (JP 2015-210908 A), different processes are performed when the temperature of a refrigerant has increased and when the temperature of a refrigerant has decreased. In JP 2015-210908 A, it is determined that the temperature of a refrigerant has increased when the temperature of the refrigerant is higher than a threshold value, and it is determined that the temperature of a refrigerant has decreased when the current density of the fuel cell at the present time is less than a threshold value.

### SUMMARY

In the technique disclosed in JP 2015-210908 A, it can be determined whether the temperature of a refrigerant has increased or decreased, but the temperature of a refrigerant cannot be predicted in advance. Accordingly, the above-mentioned determination technique cannot cope with processes which are preferably performed before the temperature of the refrigerant changes. Even if the temperature of a refrigerant could be predicted in advance, it is not possible to cope with the above-mentioned process by only predicting the temperature of the refrigerant in the very near future. Accordingly, it is preferable that change of the temperature of a refrigerant be predicted in advance over a predetermined period.

Therefore, the present disclosure provides a monitoring device of a fuel cell, a control device of a fuel cell, and a monitoring method of a fuel cell that can predict temperature change of a refrigerant of a fuel cell.

A monitoring device of a fuel cell includes: an acquisition unit configured to acquire a predicted vehicle speed of a vehicle at each point on a scheduled traveling route of the vehicle which travels using a fuel cell as a power source, a temperature of a refrigerant that receives heat from the fuel cell, and a temperature of air outside the vehicle to which the refrigerant exposed to a traveling airflow of the vehicle radiates heat; and a calculation unit configured to calculate a predicted temperature of the refrigerant at a first point on the scheduled traveling route based on the predicted vehicle speed at the first point, the temperature of the refrigerant, and the temperature of the outside air and to calculate the predicted temperature at a second point subsequent to the first point on the scheduled traveling route based on the predicted vehicle speed at the second point, the calculated predicted temperature at the first point, and the temperature of the outside air.

An amount of emitted heat of a fuel cell increases as a vehicle speed increases. On the other hand, a cooling capability of the fuel cell using a refrigerant increases as the vehicle speed increases and a temperature difference between the temperature of the refrigerant and the temperature of the outside air increases. Accordingly, it is possible to predict change of the temperature of the refrigerant over a predetermined period on the scheduled traveling route based on the amount of emitted heat of the fuel cell at each point and the cooling capability of the refrigerant using the above-mentioned method.

The acquisition unit may additionally acquire a gradient at each point on the scheduled traveling route, and the calculation unit may calculate the predicted temperature at the first point based on the predicted vehicle speed and the gradient at the first point, the temperature of the refrigerant, and the temperature of the outside air and may calculate the predicted temperature at the second point based on the predicted vehicle speed and the gradient at the second point, the predicted temperature at the first point, and the temperature of the outside air.

The predicted vehicle speed may be calculated based on an average vehicle speed which is an average value of traveling speeds of a vehicle group having traveled on the scheduled traveling route.

A monitoring device of a fuel cell includes: an acquisition unit configured to acquire a predicted vehicle speed of a vehicle at each point on a scheduled traveling route of the vehicle which travels using a fuel cell as a power source, a predicted amount of generated power of the fuel cell at each point on the scheduled traveling route, a temperature of a refrigerant that receives heat from the fuel cell, and a temperature of air outside the vehicle to which the refrigerant exposed to a traveling airflow of the vehicle radiates heat; and a calculation unit configured to calculate a predicted temperature of the refrigerant at a first point on the scheduled traveling route based on the predicted vehicle speed and the predicted amount of generated power at the first point, the temperature of the refrigerant, and the temperature of the outside air and to calculate the predicted temperature at a second point subsequent to the first point on the scheduled traveling route based on the predicted vehicle speed and the predicted amount of generated power at the second point, the calculated predicted temperature at the first point, and the temperature of the outside air.

An amount of emitted heat of a fuel cell increases as an amount of generated power of the fuel cell increases. On the other hand, a cooling capability of the fuel cell using a refrigerant increases as the vehicle speed increases and a temperature difference between the temperature of the refrigerant and the temperature of the outside air increases. Accordingly, it is possible to predict change of the temperature of the refrigerant over a predetermined period on the scheduled traveling route based on the amount of emitted heat of the fuel cell at each point and the cooling capability of the refrigerant using the above-mentioned method.

The predicted amount of generated power may be calculated based on at least one of an amount of generated power of the fuel cell on the scheduled traveling route when the vehicle traveled on the scheduled traveling route and an amount of generated power of a different fuel cell mounted as a power source for traveling in a different vehicle when the different vehicle traveled on the scheduled traveling route.

The calculation unit may calculate the predicted temperatures at the first and second points based on a state of an air-conditioning device of the vehicle which is driven by the fuel cell.

The acquisition unit may acquire the predicted vehicle speed from a server which is disposed outside the vehicle by radio communication.

The acquisition unit may acquire the predicted amount of generated power from a server which is disposed outside the vehicle by radio communication.

The monitoring device of a fuel cell may further include: a result acquiring unit configured to acquire the predicted temperature calculated by the calculation unit of the monitoring device of the fuel cell and a determination result indicating that a maximum value of the calculated predicted temperatures is higher than a threshold value; and a temperature rise suppression control unit configured to start a temperature rise suppressing process of suppressing a temperature rise of the fuel cell before a temperature rise start time at which the predicted temperature starts increasing to the maximum value when the predicted temperature and the determination result are acquired.

The temperature rise suppressing process may include at least one of a process of decreasing a target temperature of the refrigerant, a process of increasing a back pressure on a cathode side of the fuel cell, and a process of increasing a target state of charge of a secondary battery that complements an amount of generated power of the fuel cell in comparison with a case in which the temperature rise suppressing process is not performed.

A monitoring method of a fuel cell includes: acquiring, as an acquisition step, a predicted vehicle speed of a vehicle at each point on a scheduled traveling route of the vehicle which travels using a fuel cell as a power source, a temperature of a refrigerant that receives heat from the fuel cell, and a temperature of air outside the vehicle to which the refrigerant exposed to a traveling airflow of the vehicle radiates heat; and calculating, as a calculation step, a predicted temperature of the refrigerant at a first point on the scheduled traveling route based on the predicted vehicle speed at the first point, the temperature of the refrigerant, and the temperature of the outside air and calculating the predicted temperature at a second point subsequent to the first point on the scheduled traveling route based on the predicted vehicle speed at the second point, the calculated predicted temperature at the first point, and the temperature of the outside air.

A monitoring method of a fuel cell includes: acquiring, as an acquisition step, a predicted vehicle speed of a vehicle at each point on a scheduled traveling route of the vehicle which travels using a fuel cell as a power source, a predicted amount of generated power of the fuel cell at each point on the scheduled traveling route, a temperature of a refrigerant that receives heat from the fuel cell, and a temperature of air outside the vehicle to which the refrigerant exposed to a traveling airflow of the vehicle radiates heat; and calculating, as a calculation step, a predicted temperature of the refrigerant at a first point on the scheduled traveling route based on the predicted vehicle speed and the predicted amount of generated power at the first point, the temperature of the refrigerant, and the temperature of the outside air and calculating the predicted temperature at a second point subsequent to the first point on the scheduled traveling route based on the predicted vehicle speed and the predicted amount of generated power at the second point, the calculated predicted temperature at the first point, and the temperature of the outside air.

It is possible to provide a monitoring device of a fuel cell, a control device of a fuel cell, and a monitoring method of a fuel cell that can predict a temperature change of a refrigerant of a fuel cell.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a diagram illustrating a configuration of a vehicle;

FIG. 2A is a diagram illustrating a configuration of a monitoring system;

FIG. 2B is a diagram illustrating a configuration of a server;

FIG. 3A is a diagram illustrating an example of average vehicle speeds which are stored in an HDD of the server;

FIG. 3B is a flowchart illustrating an example of control for calculating an average vehicle speed which is performed by the server;

FIG. 4 is a conceptual diagram illustrating an average vehicle speed and a gradient at each point on a scheduled traveling route;

FIG. 5 is a flowchart illustrating an example of temperature control according to an embodiment;

FIG. 6A is a map in which a required amount of generated power for a fuel cell is defined with respect to a vehicle speed and a gradient;

FIG. 6B is a map in which a predicted amount of emitted heat of a fuel cell is defined with respect to a predicted amount of generated power;

FIG. 7A is a timing chart illustrating an example of change of a predicted amount of generated power and a predicted amount of emitted heat;

FIG. 7B is a timing chart illustrating an example of change of a predicted temperature;

FIG. 7C is a timing chart illustrating an example of change of an actual temperature;

FIG. 8 is a flowchart illustrating an example of predicted temperature change calculation control;

FIG. 9A is a map in which a predicted maximum cooling capability is defined with respect to a vehicle speed and a temperature difference;

FIG. 9B is a map in which a predicted temperature gradient is defined with respect to a predicted insufficient cooling capability when the temperature of a refrigerant is higher than a target temperature;

FIG. 10A is a flowchart illustrating an example of control according to a first modified example which is performed by the server;

FIG. 10B is a flowchart illustrating an example of control according to the first modified example which is performed by a control device of the vehicle;

FIG. 11A is a diagram illustrating a state of an air-conditioning system at the time of cooling;

FIG. 11B is a diagram illustrating a state of the air-conditioning system at the time of heating;

FIG. 12 is a map in which a relationship between an amount of generated power for a fuel cell required by an air-conditioning system and an outside air temperature is defined;

FIG. 13A is a diagram illustrating an example of an average amount of generated power which is stored in the HDD of the server;

FIG. 13B is a flowchart illustrating an example of control for calculating an average amount of generated power; and

FIG. 14 is a flowchart illustrating an example of temperature control according to a third modified example.

### DETAILED DESCRIPTION OF EMBODIMENTS

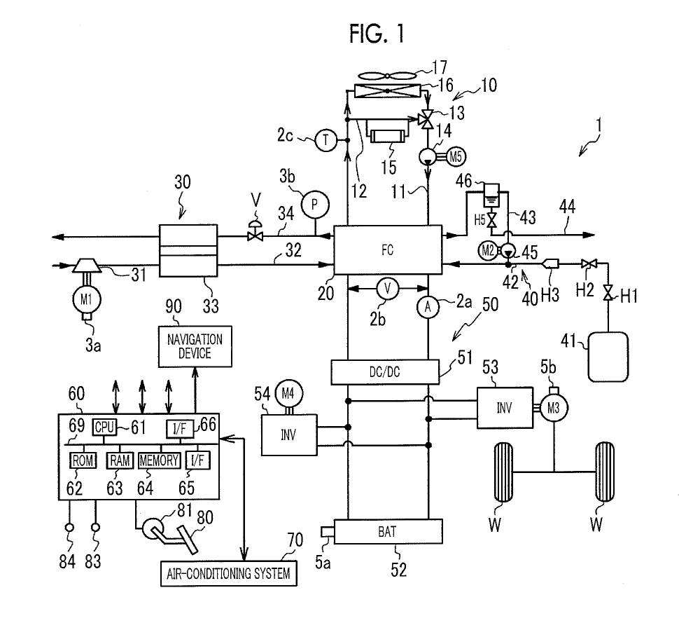

FIG. 1 is a diagram illustrating a configuration of a fuel-cell vehicle (hereinafter referred to as a vehicle). As illustrated in FIG. 1, the vehicle 1 includes a cooling system 10, an oxidant gas piping system 30, a fuel gas piping system 40, a power system 50, and a control device 60. A fuel cell 20 is supplied with oxidant gas and fuel gas and generates electric power. The cooling system 10 cools the fuel cell 20 by causing a refrigerant to circulate via a predetermined path. The oxidant gas piping system 30 supplies air containing oxygen as the oxidant gas to the fuel cell 20. The fuel gas piping system 40 supplies hydrogen gas as fuel gas to the fuel cell 20. The power system 50 charges and discharges a system with power. The control device 60 comprehensively controls the vehicle 1 as a whole. The fuel cell 20 is of a solid polymer electrolyte type and has a stacked structure in which a plurality of cells are stacked. A current sensor 2a and a voltage sensor 2b that detect an output current and an output voltage are attached to the fuel cell 20.

The oxidant gas piping system 30 includes an air compressor 31, an oxidant gas supply passage 32, a humidifier module 33, an oxidant off-gas passage 34, and a DC motor M1 that drives the air compressor 31. The air compressor 31 is driven by the motor M1, compresses air containing oxygen (oxidant gas) taken from outside air, and supplies the compressed air to a cathode of the fuel cell 20. A rotation speed sensor 3a that detects a rotation speed thereof is attached to the motor M1. The oxidant gas supply passage 32 guides air supplied from the air compressor 31 to the cathode of the fuel cell 20. Oxidant off-gas is discharged from the cathode of the fuel cell 20 via the oxidant off-gas passage 34. The humidifier module 33 appropriately humidifies oxidant gas which is supplied to the fuel cell 20. The oxidant off-gas passage 34 discharges the oxidant off-gas out of the system and a back-pressure control valve V is disposed in the vicinity of a cathode outlet. A pressure sensor 3b that detects a cathode back pressure is attached between the fuel cell 20 and the back-pressure control valve V in the oxidant off-gas passage 34.

The fuel gas piping system 40 includes a fuel gas supply source 41, a fuel gas supply passage 42, a fuel gas circulation passage 43, an anode off-gas passage 44, a hydrogen circulation pump 45, a gas-liquid separator 46, and a motor M2 that drives the hydrogen circulation pump 45. The fuel gas supply source 41 is a tank that supplies hydrogen gas as the fuel gas to the fuel cell 20. The fuel gas supply passage 42 guides fuel gas discharged from the fuel gas supply source 41 to an anode of the fuel cell 20, and a tank valve H1, a hydrogen pressure control valve H2, and an injector H3 are sequentially arranged from an upstream side. The valves and the injector supply fuel gas to the fuel cell 20 or cut off the supply of fuel gas. The fuel gas circulation passage 43 returns unreacted fuel gas to the fuel cell 20, and the gas-liquid separator 46, the hydrogen circulation pump 45, and a check valve which is not illustrated are sequentially arranged from an upstream side. Unreacted fuel gas discharged from the fuel cell 20 is appropriately pressurized by the hydrogen circulation pump 45 and is guided to the fuel gas supply passage 42. An exhaust/drain valve H5 that discharges anode off-gas containing hydrogen off-gas discharged from the fuel cell 20 or water stored in the gas-liquid separator 46 out of the system is disposed in the anode off-gas passage 44.

The power system 50 includes a high-voltage DC/DC converter 51, a battery 52, a traction inverter 53, an auxiliary machinery inverter 54, a traction motor M3, and an auxiliary machinery motor M4. The high-voltage DC/DC converter 51 can adjust a DC voltage from the fuel cell 20 and output the adjusted DC voltage to the battery 52. An output voltage of the fuel cell 20 is controlled by the high-voltage DC/DC converter 51. The battery 52 is a secondary battery which is chargeable and dischargeable and can be charged with extra power or can supply auxiliary power. A part of DC power generated in the fuel cell 20 is stepped up/down by the high-voltage DC/DC converter 51 and charges the battery 52. An SOC sensor 5a that detects a state of charge of the battery 52 is attached to the battery 52. The traction inverter 53 and the auxiliary machinery inverter 54 convert DC power output from the fuel cell 20 or the battery 52 into three-phase AC power and supply the AC power to the traction motor M3 and the auxiliary machinery motor M4. The traction motor M3 drives wheels W of the vehicle. When the traction motor M3 performs regeneration, output power from the traction motor M3 is converted into DC power via the traction inverter 53 and charges the battery 52. A rotation speed sensor 5b that detects a rotation speed is attached to the traction motor M3.

The cooling system 10 includes a radiator 16, a fan 17, a circulation passage 11, a bypass passage 12, a three-way valve 13, a circulation pump 14, a motor M5, an ion exchanger 15, and a temperature sensor 2c. A refrigerant fed by the circulation pump 14 flows in the circulation passage 11 and exchanges heat with air blown from the fan 17 and a traveling airflow of the vehicle 1 in the radiator 16, and thus the refrigerant is cooled. The cooled refrigerant is supplied to the fuel cell 20 to cool the fuel cell 20. The temperature sensor 2c detects a temperature of the refrigerant discharged from the fuel cell 20. The bypass passage 12 branches from the circulation passage 11 to bypass the radiator 16, and the three-way valve 13 adjusts an amount of refrigerant supplied to the radiator 16. The ion exchanger 15 is disposed in the bypass passage 12 such that a part of the refrigerant flowing in the bypass passage 12 flows therein. The motor M5 drives the circulation pump 14 to adjust an amount of refrigerant supplied to the fuel cell 20. The temperature of the fuel cell 20 is kept at a substantially constant temperature by adjusting a rotation speed of the motor M5 or an amount of refrigerant supplied to the radiator 16 such that the temperature of the refrigerant detected by the temperature sensor 2c is a target temperature.

An air-conditioning system 70 that cools and heats a vehicle interior is mounted in the vehicle 1. Details of the air-conditioning system 70 will be described later.

The control device 60 includes a central processing unit (CPU) 61, a read only memory (ROM) 62, a random access memory (RAM) 63, a memory 64, a network interface 65, and an input/output interface 66, which are connected to each other via a bus 69. The control device 60 comprehensively controls the units of the system based on various sensor signals which are input to the control device 60. Specifically, the CPU 61 of the control device 60 controls power generation of the fuel cell 20 based on sensor signals sent from an accelerator pedal sensor 81 that detects rotation of an accelerator pedal 80, a vehicle speed sensor 83, an outside air temperature sensor 84, an SOC sensor 5a, and a rotation speed sensor 5b via the input/output interface 66. The control device 60 controls the rotation speed of the motor M5 of the circulation pump 14 or a state of the three-way valve 13 such that the temperature of the refrigerant is a target temperature. The input/output interface 66 is connected to a navigation device 90 or an air-conditioning system 70. A storage unit of the navigation device 90 stores map data, previous traveling history of the vehicle 1, and the like. The navigation device 90 has a global positioning system (GPS) receiver that acquires positional information of the vehicle 1 therein. The CPU 61 of the control device 60 can wirelessly communicate with a server 100 via a network N which will be described later using the network interface 65.

The control device 60 can perform control of predicting change of the temperature of the refrigerant. This control details of which will be described later is performed by an acquisition unit, a calculation unit, and a temperature rise suppression control unit which are functionally realized by the CPU 61, the ROM 62, the RAM 63, and the memory 64 of the control device 60. Accordingly, the control device 60 is an example of a monitoring device of the fuel cell 20 and is also an example of a control device of the fuel cell 20. Details thereof will be described later.

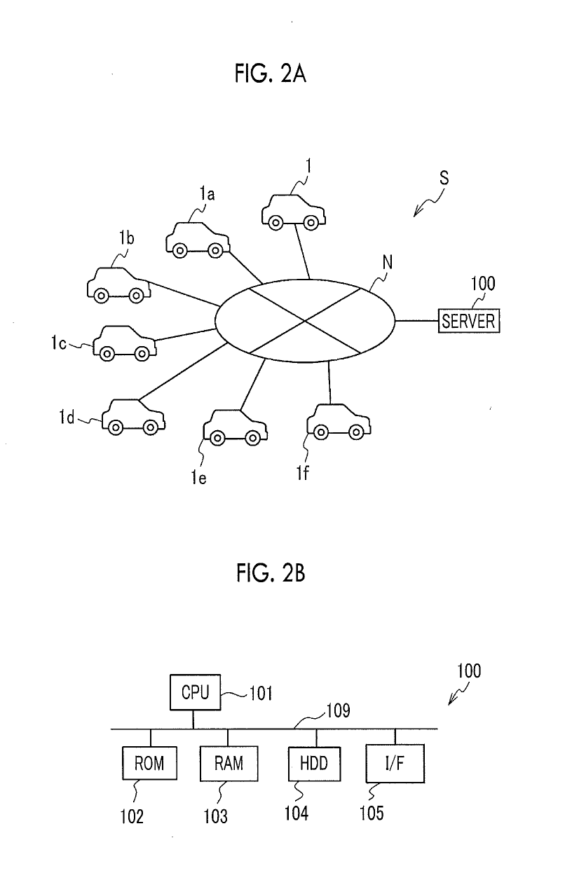

FIG. 2A is a diagram illustrating a configuration of a monitoring system S. In the monitoring system S, a vehicle group and a server 100 are connected to a network N such as the Internet. Specifically, control devices which are mounted in vehicles 1 to 1f are connected to the network N. Here, the vehicles 1a to if other than the vehicle 1 are, for example, engine vehicles, hybrid vehicles, electric vehicles, or fuel-cell vehicles. Positional information and vehicle speeds of the vehicles 1 to if in correlation with each other are wirelessly transmitted to the server 100 from the control devices of the vehicles 1 to if via the network N.

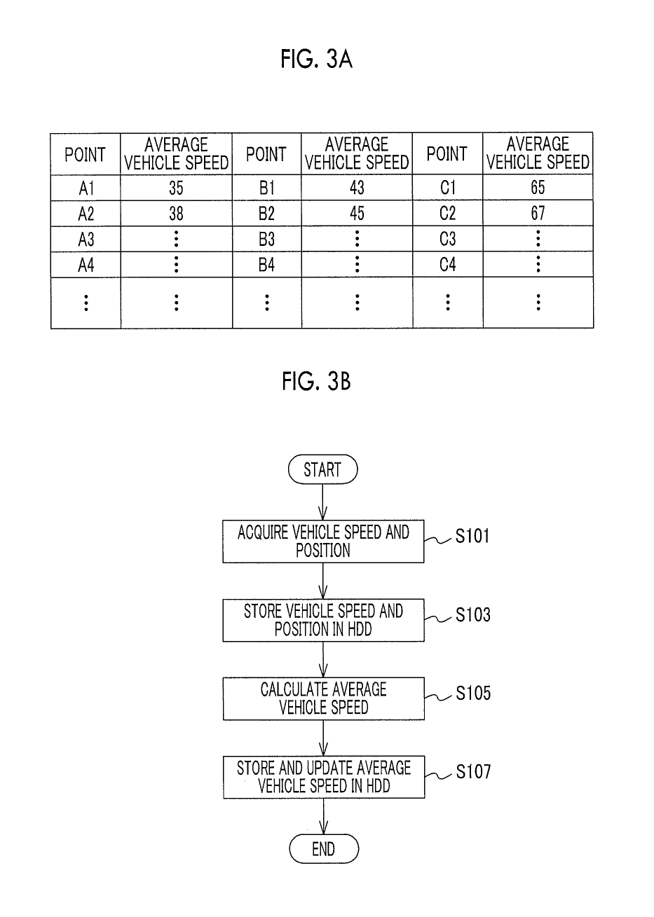

The server 100 will be described below. FIG. 2B is a diagram illustrating a configuration of the server 100. The server 100 includes a CPU 101, a ROM 102, a RAM 103, a hard disk drive (HDD) 104, and a network interface 105, which are connected to each other via a bus 109. In the server 100, various functions are embodied by causing the CPU 101 to execute programs stored in the ROM 102 or the HDD 104. The network interface 105 can communicate with the control device 60 of the vehicle 1 and can also communicate with the control devices of the vehicles 1a to 1f other than the vehicle 1. The HDD 104 stores positional information and vehicle speed information of the vehicles acquired from the vehicle group and an average vehicle speed at each point. So long as such information can be stored and held, the present disclosure is not limited to the HDD 104 and may employ other storage devices. Here, an average vehicle speed is an average value of traveling speeds of a vehicle group when the vehicle group including the vehicles 1 to if is traveling at a point. FIG. 3A is a diagram illustrating an example of average vehicle speeds stored in the HDD 104. In FIG. 3A, an average vehicle speed is calculated for each of points A1, A2, A3, A4, . . . , B1, B2, B3, B4, . . . , C1, C2, C3, C4, . . . .

Control for calculating an average vehicle speed which is performed by the CPU 101 of the server 100 will be described below. FIG. 3B is a flowchart illustrating an example of control for calculating an average vehicle speed which his performed by the server 100. This control is repeatedly performed at predetermined intervals. First, current locations of a plurality of vehicles and vehicle speeds at the locations are acquired from the vehicles via the network N (Step S101). Current locations of vehicles are acquired, for example, based on positional information from GPS receivers mounted in the vehicles. The vehicle speeds of the vehicles are acquired from vehicle speed sensors mounted in the vehicles. Then, the acquired locations and the acquired vehicle speeds are stored in the HDD 104 in correlation with each other (Step S103). Then, an average vehicle speed which is an average value of the vehicle speeds is calculated based on a plurality of vehicle speeds acquired for the same point (Step S105). The calculated average vehicle speed is stored in the HDD 104 in correlation with the corresponding point (Step S107). Accordingly, the average vehicle speed at each point is an average vehicle speed of a vehicle group including the vehicle 1 when the vehicle 1 has traveled through the point, and is an average vehicle speed of a vehicle group not including the vehicle 1 when the vehicle 1 has never traveled through the point.

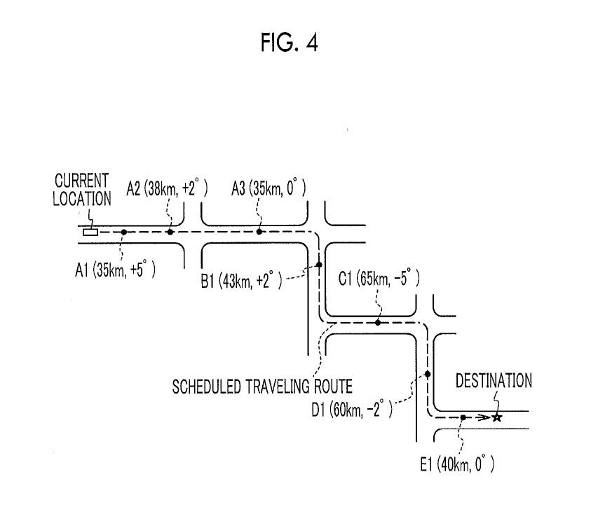

Control which is performed by the control device 60 of the vehicle 1 will be described below. The control device 60 of the vehicle 1 acquires the average vehicle speed at each point on a scheduled traveling route from a current location of the vehicle 1 to a destination from the server 100. The scheduled traveling route is a route for guiding the vehicle 1 from a current location of the vehicle 1 to a destination set in the navigation device 90 by a user using the navigation device 90. Alternatively, the scheduled traveling route is a route which is estimated from a previous traveling history stored in the navigation device 90 when a destination is not set. The control device 60 acquires the scheduled traveling route from the navigation device 90. The control device 60 acquires a gradient of a road at each point on the scheduled traveling route from which the average vehicle speed has been acquired from the map data stored in the navigation device 90. FIG. 4 is a conceptual diagram illustrating average vehicle speeds and gradients at points A1 to A3, B1, C1, D1, and E1 on the scheduled traveling route. The control device 60 calculates change of a predicted amount of generated power of the fuel cell 20 on the scheduled traveling route based on the average vehicle speed and the gradient at each point, and predicts change of the temperature of the refrigerant based on the change of the predicted amount of generated power.

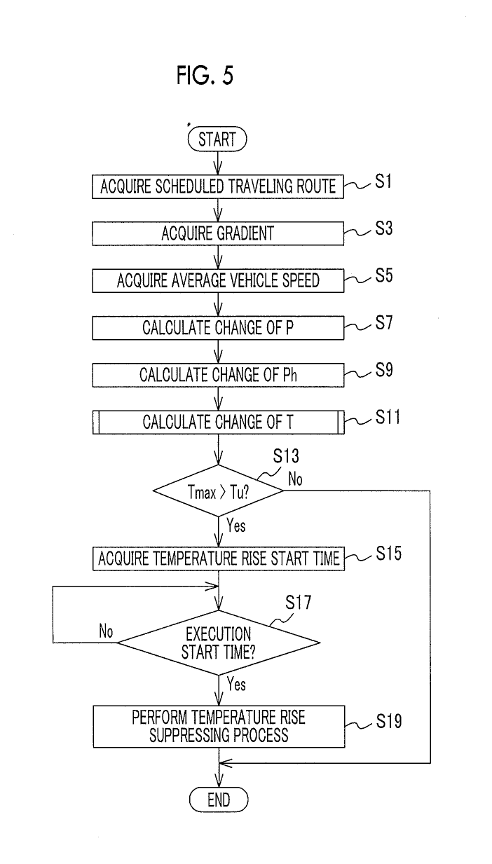

Control which is performed by the control device 60 will be specifically described below. FIG. 5 is a flowchart illustrating an example of control which is performed by the control device 60. This control is repeatedly performed at predetermined intervals. First, as described above, a scheduled traveling route is acquired from the navigation device 90 (Step S1). Then, a gradient at each point on the scheduled traveling route is acquired from the map data of the navigation device 90 (Step S3). Then, an average vehicle speed at each point on the scheduled traveling route is acquired from the server 100 which is disposed outside the vehicle 1 by radio communication (Step S5). The average vehicle speed is acquired as an example of a predicted vehicle speed of the vehicle 1 which travels on the scheduled traveling route. Although details will be described later, since an amount of emitted heat of the fuel cell 20 increases as the vehicle speed of the vehicle 1 increases, the predicted vehicle speed of the vehicle 1 is correlated with the predicted amount of emitted heat of the fuel cell 20.

Then, change of a predicted amount of generated power P [kW] which the fuel cell 20 is predicted to generate during a predetermined period, for example, 30 minutes, is calculated based on the gradient and the average vehicle speed at each point on the scheduled traveling route (Step S7). The change can be calculated using the average vehicle speed at each point and a distance between the points. The distance between the points can be acquired from the map data of the navigation device 90.

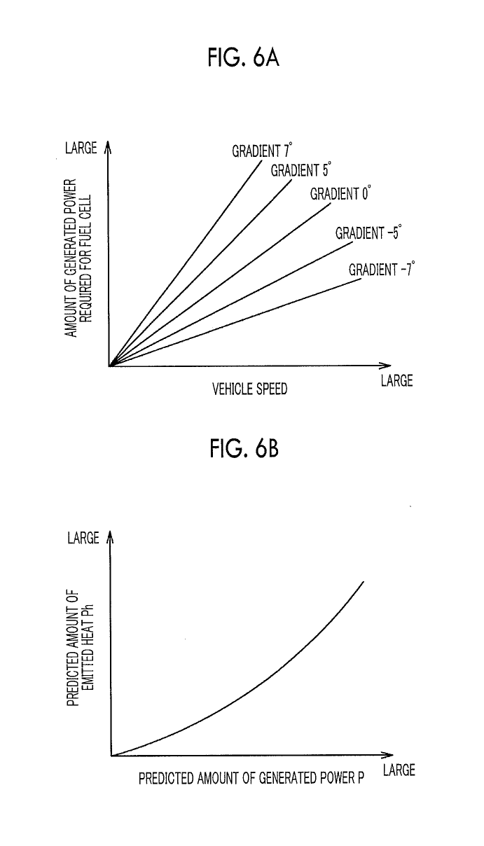

Here, the predicted amount of generated power P of the fuel cell 20 can be regarded to be substantially the same as a required amount of generated power required for the fuel cell 20 to allow the vehicle 1 to travel through a predetermined point with a predetermined gradient at the average vehicle speed at that point. Specifically, the predicted amount of generated power P of the fuel cell 20 can be regarded to be substantially the same as a power value which is consumed by the traction motor M3, the auxiliary machinery motor M4, and the like and which is required for realizing the above-mentioned traveling. FIG. 6A is a map in which a required amount of generated power of the fuel cell 20 is defined with respect to each vehicle speed and each gradient. This map is calculated by experiment in advance and is stored in the memory 64 of the control device 60 in advance. The required amount of generated power of the fuel cell 20 increases as the vehicle speed increases, increases as an uphill gradient increases, and decreases as a downhill gradient increases. The change of the predicted amount of generated power P of the fuel cell 20 on the scheduled traveling route is calculated with reference to the map.

Then, change of a predicted amount of emitted heat Ph [kW] of the fuel cell 20 is calculated based on the change of the predicted amount of generated power P (Step S9). FIG. 6B is a map in which a predicted amount of emitted heat Ph of the fuel cell 20 is defined with respect to the predicted amount of generated power P. This map is calculated by experiment in advance and is stored in the memory 64 of the control device 60 in advance. As the predicted amount of generated power P increases, the predicted amount of emitted heat Ph increases. The change of the predicted amount of emitted heat Ph of the fuel cell 20 on the scheduled traveling route is calculated with reference to the map.

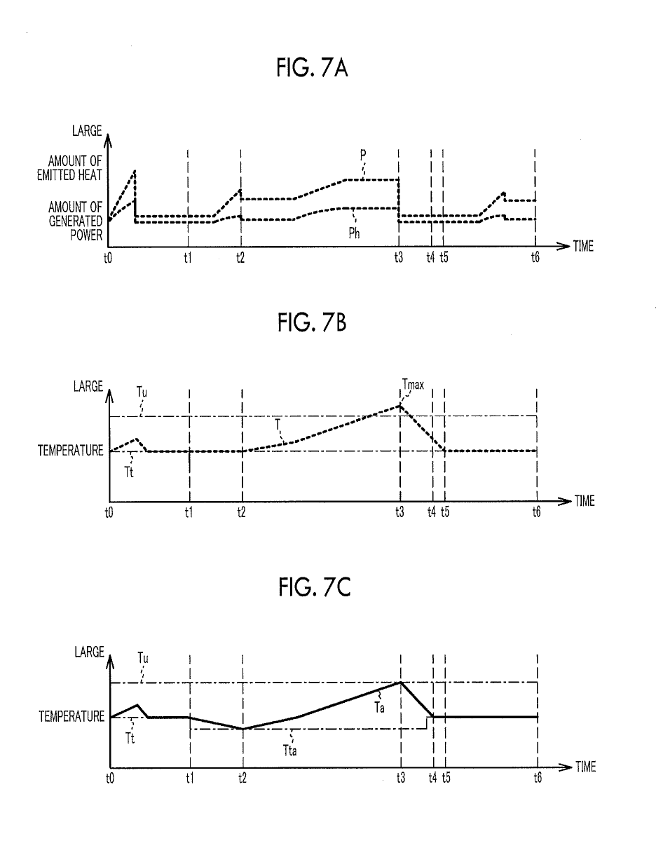

Then, change of a predicted temperature T of the refrigerant is calculated based on the change of the predicted amount of emitted heat Ph (Step S11). A specific method thereof will be described later. FIG. 7A is a timing chart illustrating an example of the change of the predicted amount of generated power P and the predicted amount of emitted heat Ph. FIG. 7B is a timing chart illustrating an example of the change of the predicted temperature T. The vertical axis in FIG. 7A represents an amount of power and an amount of emitted heat. The vertical axis in FIG. 7B represents temperature. In FIGS. 7A and 7B, the change of the predicted amount of generated power P, the predicted amount of emitted heat Ph, and the predicted temperature T from time t0 to time t6 are illustrated by dotted lines. A normal target temperature Tt of the refrigerant and a threshold value Tu to be described later are illustrated in FIG. 7B.

As illustrated in FIG. 7A, the predicted amount of emitted heat Ph increases with an increase of the predicted amount of generated power P, but the predicted temperature T does not necessarily increase. When the predicted amount of emitted heat Ph increases over a maximum cooling capability of the refrigerant to be described later, the predicted temperature T increases from the normal target temperature Tt. For example, the predicted amount of generated power P and the predicted amount of emitted heat Ph increase slightly immediately before time t2, but the predicted temperature T does not increase from the normal target temperature Tt. The reason for this is that the refrigerant is kept at the normal target temperature Tt owing to viewpoints such as securement of power generation performance of the fuel cell 20 and an amount of refrigerant supplied to the fuel cell 20 or the radiator 16 or a flow rate of air passing through the radiator 16 is adjusted such that the refrigerant is kept at the normal target temperature Tt without exceeding the maximum cooling capability of the refrigerant. In FIG. 7A, since the predicted amount of emitted heat Ph of the fuel cell 20 exceeds the maximum cooling capability of the refrigerant at time t2, the predicted temperature T starts increasing from the normal target temperature Tt. The predicted temperature T reaches a maximum value Tmax and then starts decreasing at time t3, and the predicted temperature T reaches the normal target temperature Tt at time t5.

Then, it is determined whether the maximum value Tmax of the predicted temperature T is greater than the threshold value Tu based on the change of the predicted temperature T (Step S13). When the determination result is negative, it is determined that the refrigerant and the fuel cell 20 have not increased excessively in temperature, a temperature rise suppressing process which will be described later is not performed, and the control routine ends.

When the determination result is positive, a temperature rise start time at which the predicted temperature T starts increasing to the maximum value Tmax is acquired (Step S15). In the example illustrated in FIG. 7B, since the maximum value Tmax is greater than the threshold value Tu, time t2 is acquired as the temperature rise start time. Time t2 is a time which is traced back from time t3 at which the predicted temperature T becomes the maximum value Tmax, which is closest to time t3, and at which the predicted temperature T becomes the normal target temperature Tt.

Then, it is determined whether the present time is an execution start time of the temperature rise suppressing process (Step S17). The execution start time of the temperature rise suppressing process is prior to the above-mentioned temperature rise start time. When the determination result is negative, the process of Step S17 is performed again. When the determination result is positive, the temperature rise suppressing process is performed (Step S19). FIG. 7C is a timing chart illustrating change of an actual temperature Ta of the refrigerant when temperature rise suppression control is performed. In the example illustrated in FIG. 7C, the temperature rise suppressing process is performed at time t1 prior to time t2 which is the temperature rise start time of the predicted temperature T. The temperature rise suppressing process in this embodiment is a process of setting a target temperature of the refrigerant to a low target temperature Tta lower by a predetermined temperature than the normal target temperature Tt before the predicted temperature T starts increasing. Accordingly, in comparison with a case in which the temperature rise suppressing process is not performed, at least one of a process of increasing an amount of refrigerant supplied to the fuel cell 20, a process of increasing an amount of refrigerant supplied to the radiator 16, and a process of increasing a flow rate of air passing through the radiator 16 is performed, and the temperature of the refrigerant decreases to the low target temperature Tta. Accordingly, the temperature of the fuel cell 20 also decreases. The increasing of the amount of refrigerant supplied to the fuel cell 20 is realized by increasing a rotation speed of the motor M5 of the circulation pump 14. The increasing of the amount of refrigerant supplied to the radiator 16 is performed by increasing the rotation speed of the motor M5 or decreasing an amount of refrigerant flowing through the bypass passage 12 using the three-way valve 13. The increasing of the flow rate of air passing through the radiator 16 is realized by increasing the rotation speed of the fan 17.

Since the temperature rise suppressing process is started at time t1 prior to time t2, the actual temperature Ta decreases from time t1 to time t2, and can be lower than the predicted temperature T at time t2 at which the temperature rise starts. Accordingly, even when the temperature of the refrigerant starts increasing at time t2, the actual temperature Ta is prevented from exceeding the threshold value Tu at time t3, and then the actual temperature Ta decreases to the normal target temperature Tt at time t4 prior to time t5. In this way, since the temperature rise suppressing process is performed before the temperature rise of the refrigerant starts, it is possible to effectively suppress excessive temperature rise of the fuel cell 20 and to minimize deterioration in power generation performance of the fuel cell 20 due to excessive temperature rise. The process of Step S19 is an example of a process which is performed by the temperature rise suppression control unit that starts the temperature rise suppressing process of suppressing a temperature rise of the fuel cell 20 before time t2 at which the predicted temperature T starts increasing to the maximum value Tmax when the determination result of Step S13 is positive.

Time t1 at which the temperature rise suppressing process is started may be determined based on a period which is estimated as a period required for the actual temperature Ta to decrease from the normal target temperature Tt to the low target temperature Tta according to the outside air temperature or the like. Time t1 may be set to a time prior to time t2 by a predetermined time, for example, five minutes.

A time at which the temperature rise suppressing process stops, that is, a time at which the target temperature of the refrigerant is returned from the low target temperature Tta to the normal target temperature Tt, is in a period from time t3 at which the temperature becomes the maximum value Tmax to time t5 at which the predicted temperature T is the normal target temperature Tt in the example illustrated in FIG. 7C, but the present disclosure is not limited thereto. For example, at a time point at which the actual temperature Ta exceeds the normal target temperature Tt, the target temperature of the refrigerant may be returned from the low target temperature Tta to the normal target temperature Tt. At a time point at which the actual temperature Ta exceeds the normal target temperature Tt, the rotation speed of the motor M5 or the like is controlled such that the cooling capability of the refrigerant is maximized, and the amount of emitted heat of the fuel cell 20 exceeds the maximum cooling capability. Accordingly, even when the target temperature of the refrigerant is kept at the low target temperature Tta, the actual temperature Ta has no influence.

The temperature rise suppressing process is not limited to the process of decreasing the target temperature of the refrigerant form the normal target temperature Tt to the low target temperature Tta as described above. For example, the temperature rise suppressing process may be a process of increasing a back pressure on the cathode side of the fuel cell 20 by decreasing an opening level of the back-pressure control valve V in comparison with a case in which the temperature rise suppressing process is not performed. Accordingly, an amount of liquid water discharged from the fuel cell 20 decreases and thus a dry state in the fuel cell 20 is suppressed to achieve a satisfactory wet state. Accordingly, since power generation efficiency of the fuel cell 20 is improved, it is possible to decrease an amount of emitted heat with respect to an amount of generated power of the fuel cell 20 and to suppress excessive temperature rise of the fuel cell 20.

The temperature rise suppressing process may be a process of increasing a target state of charge of a secondary battery 52 for complementing the amount of generated power of the fuel cell 20 in comparison with a case in which the temperature rise suppressing process is not performed. By previously increasing the target state of charge of the secondary battery 52 before the predicted temperature T starts increasing and returning the target state of charge to an original state and increasing an amount of discharged power of the secondary battery 52 before the predicted temperature T starts increasing, it is possible to minimize an amount of generated power required for the fuel cell 20 and to suppress excessive temperature rise of the fuel cell 20.

The temperature rise suppressing process may include two or more of the process of decreasing the target temperature from the normal target temperature Tt to the low target temperature Tta, the process of increasing the back pressure on the cathode side of the fuel cell 20 by decreasing the opening level of the back-pressure control valve V, and the process of increasing the target state of charge of the secondary battery 52 for complementing the amount of generated power of the fuel cell 20. Accordingly, it is possible to more effectively suppress excessive temperature rise of the fuel cell 20.

A process which can be performed after the change of the predicted temperature T has been calculated is not limited to the above-mentioned temperature rise suppressing process. For example, a process of displaying the change of the predicted temperature T on a display disposed in an instrument panel of the vehicle 1 may be performed. A process of giving an alarm sound to a driver before the actual temperature Ta exceeds the threshold value Tu only when the predicted temperature T exceeds the threshold value Tu may be performed. A process of correcting an amount of oxidant gas or fuel gas supplied to the fuel cell 20 based on the predicted temperature T may be performed. A predetermined process may be performed when an absolute value of a gradient with which the predicted temperature T increases or decreases is greater than a predetermined threshold value or when a locus length of the predicted temperature T in a predetermined period is greater than a threshold value.

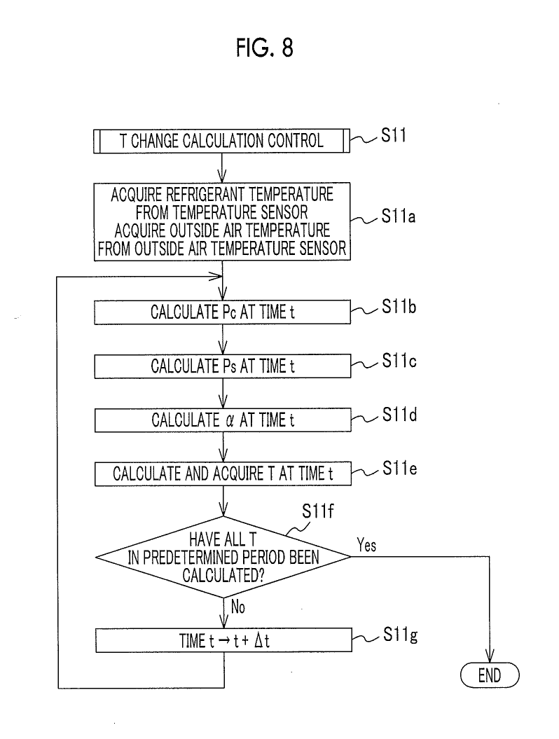

Control of calculating the change of the predicted temperature T will be described below in detail. FIG. 8 is a flowchart illustrating an example of the change calculation control of the predicted temperature T. In the change calculation control of the predicted temperature T, the change of the predicted temperature T over a predetermined time is calculated by repeatedly performing the processes of Steps S11b to S11g until the determination result of Step S11f to be described later is positive.

First, a temperature of a refrigerant is acquired from the temperature sensor 2c and an outside air temperature is acquired from the outside air temperature sensor 84 (Step S11a). Since the temperature sensor 2c is disposed downstream from the fuel cell 20 and upstream from a branching point to the bypass passage 12 as described above, the temperature of the refrigerant having received heat from the fuel cell 20 is acquired by the temperature sensor 2c. The processes of Steps S3, S5, and S11a are an example of a process which is performed by the acquisition unit that acquires the predicted vehicle speed of the vehicle 1 at each point on the scheduled traveling route of the vehicle 1 traveling using the fuel cell 20 as a power source, the temperature of the refrigerant having received heat from the fuel cell 20, and the temperature of the outside air of the vehicle 1 to which the refrigerant exposed to a traveling airflow of the vehicle 1 radiates heat.

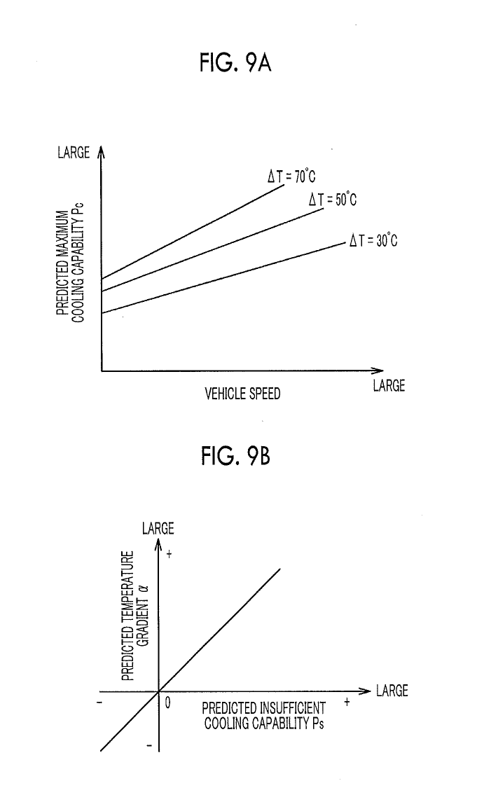

Then, a predicted maximum cooling capability Pc [kW] at time t is calculated (Step S11b). Here, time t is a time in the future close to the present time in performing Step S11b at the first time, for example, a time after one to ten seconds elapses from the present time. Here, the predicted maximum cooling capability Pc refers to an amount of heat of the fuel cell 20 which can be removed by the refrigerant per unit time when the rotation speed of the motor M5 of the circulation pump 14 is set to an upper limit value, the three-way valve 13 cuts off the bypass passage 12 to allow all the refrigerant to flow in the radiator 16, and the rotation speed of the fan 17 is set to an upper limit value. The predicted maximum cooling capability Pc depends on a vehicle speed and a temperature difference ΔT obtained by subtracting the temperature of the outside air from the temperature of the refrigerant having received heat from the fuel cell 20. FIG. 9A is a map in which the predicted maximum cooling capability Pc is defined with respect to the vehicle speed and the temperature difference ΔT. This map is calculated by experiment in advance and is stored in the memory 64 of the control device 60. The predicted maximum cooling capability Pc increases as the vehicle speed increases, and increases as the temperature difference ΔT increases. This is because as the vehicle speed increases, the radiator 16 is exposed to strong a traveling airflow and sufficiently radiates heat of the refrigerant. Accordingly, as the vehicle speed increases as described above, the amount of generated power of the fuel cell 20 increases, the amount of emitted heat increases, and is correlated with the cooling capability of the fuel cell 20. As the temperature difference ΔT increases, the temperature of the outside air is lower than the temperature of the refrigerant and the radiator 16 can sufficiently radiate heat of the refrigerant. With reference to this map, the predicted maximum cooling capability Pc of the refrigerant at time t on the scheduled traveling route is calculated based on the average vehicle speed and the temperature difference ΔT at time t on the scheduled traveling route. At the time of performing Step S11b at the first time, the outside air temperature which is used to calculate the temperature difference ΔT is acquired by the outside air temperature sensor 84 and the temperature acquired in Step S11a is used as the temperature of the refrigerant.

Then, a predicted insufficient cooling capability Ps [kW] at time t is calculated (Step S11c). The predicted insufficient cooling capability Ps at time t is a value obtained by subtracting the predicted maximum cooling capability Pc of the refrigerant at time t from the predicted amount of emitted heat Ph at time t. The predicted amount of emitted heat Ph at time t can be acquired from the change of the predicted amount of emitted heat Ph calculated in Step S9.

Then, a predicted temperature gradient α [° C./sec] which is a temperature gradient of the refrigerant predicted at time t is calculated (Step S11d). Specifically, the predicted temperature gradient α is calculated based on the predicted insufficient cooling capability Ps [kW]. The predicted insufficient cooling capability Ps corresponds to a cooling capability of a shortage when the predicted amount of emitted heat Ph exceeds the predicted maximum cooling capability Pc. FIG. 9B is a map in which the predicted temperature gradient α is defined with respect to the predicted insufficient cooling capability Ps when the temperature of the refrigerant is higher than the target temperature. This map is calculated by experiment in advance and is stored in the memory 64 of the control device 60. When the predicted insufficient cooling capability Ps has a positive value, the predicted maximum cooling capability Pc does not correspond to the predicted amount of emitted heat Ph and thus the predicted temperature gradient α increases as the predicted insufficient cooling capability Ps increases. That is, the gradient of the temperature rise of the refrigerant is steep. When the predicted insufficient cooling capability Ps has a negative value, the predicted maximum cooling capability Pc is greater than the predicted amount of emitted heat Ph. Here, when the temperature of the refrigerant is higher than the target temperature, the predicted temperature gradient α has a negative value and decreases when the temperature of the refrigerant reaches the target temperature. On the other hand, when the temperature of the refrigerant is equal to or lower than the target temperature, one of the circulation pump 14, the three-way valve 13, and the fan 17 is controlled such that the temperature of the refrigerant is kept at the target temperature.

Then, the predicted temperature T at time t is calculated and acquired (Step S11e). Specifically, a value obtained by adding the temperature of the refrigerant acquired in Step S11a to a value obtained by multiplying the predicted temperature gradient α calculated in Step S11d by a minute period Δt to be described later is calculated as the predicted temperature T.

Then, it is determined whether all the predicted temperatures T in a predetermined period have been calculated (Step S11f). When the determination result is positive, this control routine ends. When the determination result is negative, time t is replaced with a time obtained by adding the minute period Δt to time t (Step S11g), and the processes of Step S11b and steps subsequent thereto are repeatedly performed. Here, the minute period Δt is an arbitrary period and ranges, for example, from about 1 to 10 seconds.

The temperature of the outside air acquired in Step S11a is used as the outside air temperature which is used to calculate the temperature difference ΔT in Step S11b which is performed at the second time. The temperature of the outside air may be acquired whenever the process of Step S11b is repeatedly performed, but it is conceivable that the temperature of the outside air is not substantially changed during an execution period of this control routine. On the other hand, the temperature of the refrigerant acquired in Step S11g is used as the temperature of the refrigerant which is used to calculate the temperature difference ΔT in Step S11b which is performed at the second time. Accordingly, a predicted temperature T acquired in the (n−1)-th Step S11e is used as the temperature of the refrigerant which is used to calculate the temperature difference ΔT in Step S11b which is performed at the n-th time (n≥2).

In the n-th (n≥2) step S11c, a value obtained by subtracting the predicted maximum cooling capability Pc calculated in the n-th step S11b from the predicted amount of emitted heat Ph at time (t+(n−1)×Δt) is calculated as the predicted insufficient cooling capability Ps. The predicted amount of emitted heat Ph at time (t+(n−1)×Δt) can be acquired from the change of the predicted amount of emitted heat Ph calculated in Step S9.

As described above, in the n-th (n≥2) step S11e, the predicted temperature T at time (t+(n−1)×Δt) is calculated. In this way, by repeatedly performing the processes of Steps S11b to S11h, the predicted temperature T for each minute period Δt is calculated and the change of the predicted temperature T over a predetermined period is calculated. That is, the predicted temperature T at each point on the scheduled traveling route is calculated. The process of Step S11e is an example of a process which is performed by the calculation unit that calculates the predicted temperature of the refrigerant at the first point based on the predicted vehicle speed at the first point on the scheduled traveling route, the temperature of the refrigerant, and the temperature of the outside air and calculates the predicted temperature at the second point subsequent to the first point on the scheduled traveling route based on the predicted vehicle speed at the second point, the calculated predicted temperature at the first point, and the temperature of the outside air. The period until Step S11e is performed again after Step S11e is performed needs to be shorter than the minute period Δt.

As described above, the change of the predicted temperature T is accurately calculated based on the predicted amount of emitted heat Ph at each point calculated based on the gradient and the predicted vehicle speed at each other point on the scheduled traveling route and the cooling capability of the refrigerant at each point.

In the above-mentioned embodiment, an average vehicle speed acquired from the server 100 is used as an example of the predicted vehicle speed of the vehicle 1, but the predicted vehicle speed is not limited thereto. For example, the predicted vehicle speed may be an average vehicle speed of a vehicle group sorted according to a predetermined criterion among all the vehicles, instead of the average vehicle speed of all the vehicles which have traveled on the scheduled traveling route. For example, an average vehicle speed of a vehicle group corresponding to the vehicle 1 among average vehicle speeds of a vehicle group with a large number of times in which an acceleration is equal to or higher than a predetermined value in a section of a predetermined traveling distance and a vehicle group with a small number of times may be used as the predicted vehicle speed of the vehicle 1. In this case, the server 100 sorts the vehicles into the vehicle group with a large number of times and the vehicle group with a small number of times based on the accelerations transmitted from the vehicles 1 to if from time to time, and calculates and stores the average vehicle speeds of the vehicle groups in the HDD 104. The control device 60 of the vehicle 1 acquires the average vehicle speed of the vehicle group corresponding to the vehicle 1 from the HDD 104. Accordingly, it is possible to acquire the predicted vehicle speed of the vehicle 1 based on driving habits of a driver of the vehicle 1 and to further accurately calculate the change of the predicted temperature T. Similarly, an average vehicle speed of a vehicle group corresponding to the vehicle 1 among average vehicle speeds of a vehicle group with a large number of times in which the vehicle speed is higher than a threshold value correlated with a speed limit at each point and a vehicle group with a small number of times may be used as the predicted vehicle speed of the vehicle 1. In this case, the server 100 sorts the vehicles into the vehicle group with a large number of times and the vehicle group with a small number of times based on the difference between the vehicle speed at each point transmitted from the vehicles 1 to 1f and the threshold value correlated with the speed limit, and calculates and stores the average vehicle speeds of the vehicle groups in the HDD 104. The control device 60 of the vehicle 1 acquires the average vehicle speed of the vehicle group corresponding to the vehicle 1 from the HDD 104 with reference to the identification information of the vehicle 1 and the identification information stored in the HDD 104. Examples of the identification information of the vehicle include a registered number shown in a number plate, a frame number, and a serial number of the fuel cell in case of a fuel-cell vehicle.

The newest average vehicle speed stored in the server 100 is used as an example of the predicted vehicle speed of the vehicle 1, but the present disclosure is not limited thereto and, for example, a previous average vehicle speed may be used. As the previous average vehicle speed, for example, an average vehicle speed at the same time on a previous day may be used or an average vehicle speed on the same day of the last week may be used. In this case, the server 100 stores a position, a vehicle speed, and a date and time transmitted from each vehicle in correlation with each other in the HDD 104, calculates an average vehicle speed at each point for each date and time, and stores the calculated average vehicle speed in the HDD 104. That is, information on the average vehicle speed illustrated in FIG. 4B is stored in the HDD 104 for each date and time.

The predicted vehicle speed of the vehicle 1 may be calculated based on the average vehicle speed stored in the server 100. For example, the predicted vehicle speed may be a vehicle speed which is obtained by subtracting or adding a predetermined speed from or to the average vehicle speed stored in the server 100. For example, when a speed difference obtained by subtracting the average vehicle speed stored in the server 100 from the actual vehicle speed of the vehicle 1 in a predetermined traveling section is a positive value equal to or greater than a predetermined value, a value obtained by multiplying the average vehicle speed by a coefficient m (m>1) may be set as the predicted vehicle speed, and when the speed difference has a negative value and the absolute value of the speed difference is equal to or greater than a predetermined value, a value obtained by multiplying the average vehicle speed by a coefficient 1 (0<1<1) may be set as the predicted vehicle speed. In this case, the control device 60 of the vehicle 1 may store the actual vehicle speed of the vehicle 1 in a predetermined traveling section and may calculate the predicted vehicle speed based on the actual vehicle speed and the average vehicle speed acquired from the server 100. The control device 60 of the vehicle 1 may transmit the actual vehicle speed of the vehicle 1 to the server 100 and the server 100 may calculate the predicted vehicle speed based on the actual vehicle speed and the average vehicle speed and may transmit the calculated predicted vehicle speed to the control device 60.

The predicted amount of emitted heat Ph with respect to the predicted amount of generated power P may be corrected to increase as a degree of deterioration of output performance of the fuel cell 20 increases. For example, since the output performance of the fuel cell 20 decreases as a cumulative operation period or a cumulative traveling distance of the vehicle 1 increases, the predicted amount of emitted heat Ph with respect to the predicted amount of generated power P is corrected to increase as the cumulative operation period or the like increases. Accordingly, it is possible to more accurately calculate the change of the predicted temperature T. In this case, a map in which a coefficient for correcting the predicted amount of emitted heat Ph is defined with respect to a parameter correlated with the deterioration in output performance may be stored in the memory 64 of the control device 60 in advance and the predicted amount of emitted heat Ph may be corrected with reference to the map.

The predicted vehicle speed of the vehicle 1 may be a vehicle speed when the vehicle 1 actually traveled on the scheduled traveling route in the past, which is stored in the server 100. In this case, the server 100 stores identification information, a position, and a vehicle speed of the vehicle 1 transmitted from the control device 60 of the vehicle 1 in the HDD 104 from time to time. The control device 60 of the vehicle 1 acquires the vehicle speed on the scheduled traveling route of the vehicle 1 from the HDD 104 and uses the acquired vehicle speed of the vehicle 1 as the predicted vehicle speed. The predicted vehicle speed of the vehicle 1 may be a vehicle speed in the same time zone at each point on the scheduled traveling route on which the vehicle 1 traveled in the past. In this case, the server 100 stores the identification information, the position, and the vehicle speed of the vehicle 1 transmitted from the control device 60 of the vehicle 1 and the date and time in the HDD 104 in correlation with each other.

A speed limit at each point of the map data stored in advance in the navigation device 90 or a speed limit at each point stored in advance in the HDD 104 of the server 100 may be used as the predicted vehicle speed of the vehicle 1. The speed limit stored in the navigation device 90 may be corrected by adding congestion information which can be acquired by the navigation device 90 to the speed limit. In this case, a value obtained by multiplying the speed limit by a correction coefficient based on a past traveling history of a driver stored in the navigation device 90 or the like may be used as the predicted vehicle speed of the vehicle 1. The gradient of each point may be acquired from the server 100, when the gradients are stored in the HDD 104 of the server 100 in advance.

In the above-mentioned embodiment, the control device 60 acquires the scheduled traveling route from the navigation device 90 which is mounted in the vehicle 1, but the present disclosure is not limited thereto. For example, when a previous traveling route of the vehicle 1 is stored in the HDD 104 of the server 100, the control device 60 may acquire the previous traveling route as the scheduled traveling route. In this case, the server 100 stores a route from a departure to a destination on which the vehicle 1 has traveled as a traveled route in the HDD 104 in correlation with the identification information and the position of the vehicle 1 transmitted from the control device 60. The control device 60 acquires the traveled route of the vehicle 1 from the server 100, sets the arrived location of the traveled route as a destination of the current traveling when the current location of the vehicle 1 is included in the traveled route, and acquires a route from the current location to the destination as the scheduled traveling route.

In the above-mentioned embodiment, the predicted amount of generated power P of the fuel cell 20 is regarded to be substantially the same as the required amount of generated power required for the fuel cell 20 based on the gradient and the vehicle speed, but the present disclosure is not limited thereto. For example, in consideration of an amount of generated power of a battery 52 for complementing the amount of generated power of the fuel cell 20, a value obtained by subtracting a predetermined value corresponding to the complemented amount of power of the battery 52 from the required amount of generated power required for the fuel cell 20 based on the gradient and the vehicle speed may be used as the predicted amount of generated power of the fuel cell 20. In consideration of the amount of generated power of the battery 52 for complementing the amount of generated power of the fuel cell 20, a value obtained by multiplying the required amount of generated power of the fuel cell 20 by a predetermined coefficient k (0<k<1) may be used as the predicted amount of generated power of the fuel cell 20.

In the above-mentioned embodiment, the required amount of generated power of the fuel cell 20 is calculated based on the gradient and the predicted vehicle speed, the required amount of generated power is regarded as the predicted amount of generated power P, and the predicted amount of emitted heat Ph is calculated based on the predicted amount of generated power P, but the present disclosure is not limited thereto. For example, the change of the predicted amount of emitted heat Ph may be directly calculated with reference to a map in which the predicted amount of emitted heat Ph is defined with respect to the gradient and the vehicle speed. The order of Steps S3 and S5 may be reversed.

A plurality of modified examples will be described below. In the following modified examples, the processes identical or similar to those in the above-mentioned embodiment will be referenced by identical or similar reference signs and description thereof will not be repeated. In a first modified example, the server 100 calculates change of the predicted temperature T and the control device 60 of the vehicle 1 performs the temperature rise suppression control process. Specifically, the server 100 realizes the functions of the acquisition unit and the calculation unit and corresponds to the monitoring device of the fuel cell 20. The control device 60 realizes the functions of the result acquisition unit to be described later and the above-mentioned temperature rise suppression control unit.

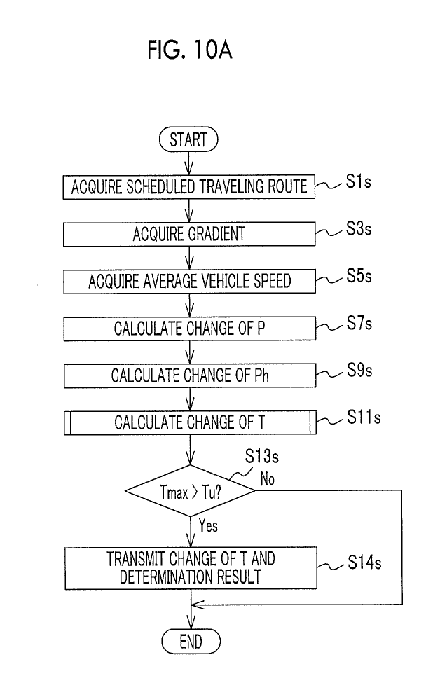

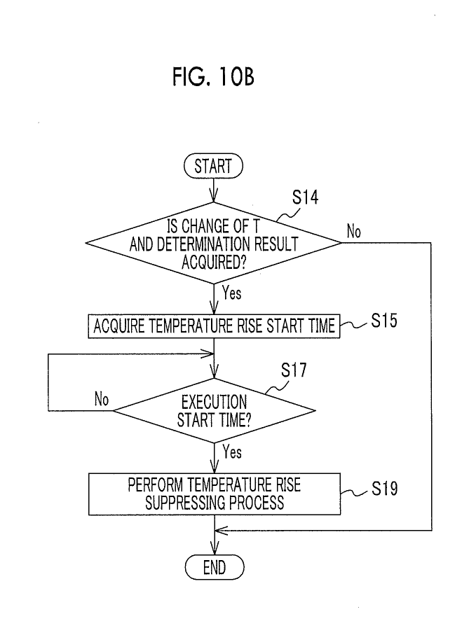

First, control which is performed by the server 100 will be described. FIG. 10A is a flowchart illustrating an example of control according to the first modified example which is performed by the server 100. First, a scheduled traveling route of the navigation device 90 is acquired via the control device 60 of the vehicle 1 (Step S1s), and the gradient and the average vehicle speed at each point on the scheduled traveling route are acquired from the map data stored in the HDD 104 (Steps S3s and S5s). The predicted amount of generated power P, the predicted amount of emitted heat Ph, and the change of the predicted temperature T are calculated based on the maps illustrated in FIGS. 6A, 6B, 9A, and 9B corresponding to the vehicle 1, which are stored in the HDD 104 (Steps S7s to S11s). The change of the predicted temperature T is calculated in the same way as illustrated in FIG. 8. That is, the server 100 calculates the change of the predicted temperature T based on the temperature of the refrigerant or the outside air temperature acquired via the control device 60 of the vehicle 1. Then, it is determined whether the maximum value Tmax of the predicted temperature T is greater than the threshold value Tu (Step S13a), and the control routine ends when the determination result is negative. When the determination result is positive, the calculated change of the predicted temperature T and the determination result indicating that the maximum value Tmax is greater than the threshold value Tu are transmitted to the control device 60 of the vehicle 1 (Step S14s).

Control which is performed by the control device 60 of the vehicle 1 will be described below. FIG. 10B is a flowchart illustrating an example of control according to the first modified example which is performed by the control device 60 of the vehicle 1. First, it is determined whether the change of the predicted temperature T and the determination result transmitted from the server 100 have been acquired (Step S14). The process of Step S14 is an example of the process which is performed by the result acquisition unit that acquires the predicted temperature calculated by the server 100 and the determination result indicating that the maximum value Tmax of the calculated predicted temperature is greater than the threshold value Tu. When the determination result is negative, this control routine ends. When the determination result is positive, the processes of Steps S15 to S19 are performed. Since the change of the predicted temperature T is calculated by the server 100 as described above, it is possible to reduce a processing load of the control device 60 of the vehicle 1.

In the first modified example, the server 100 performs the process of Step S13s, but the server 100 may not perform the process of Step S13s and transmit only the change of the predicted temperature T to the control device 60 and the control device 60 may determine whether the maximum value Tmax is greater than the threshold value Tu based on the acquired change of the predicted temperature T. The server 100 may transmit the calculated change of the predicted temperature T to the control device 60 regardless of the determination result of Step S13s.

A second modified example will be described below. In the second modified example, the predicted amount of generated power P of the fuel cell 20 is calculated based on the amount of generated power of the fuel cell 20 which is consumed by an air-conditioning system 70. A configuration of the air-conditioning system 70 will be described before describing such an example in detail.

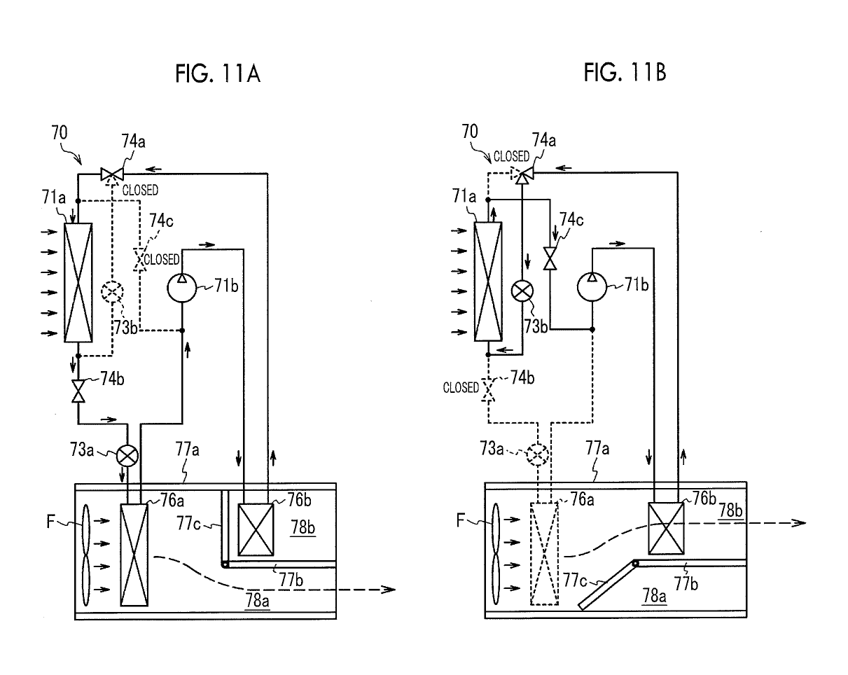

FIGS. 11A and 11B illustrate states of the air-conditioning system 70 at the time of cooling and at the time of heating. The air-conditioning system 70 includes an air-conditioning compressor 71b, an evaporator 76a, and an indoor condenser 76b, which are connected to each other via a pipe in which a refrigerant flows. At the time of cooling, ON/OFF states of a three-way valve 74a and ON/OFF valves 74b and 74c are controlled such that a refrigerant circulates as follows. As illustrated in FIG. 11A, a refrigerant in a gas phase is condensed by the air-conditioning compressor 71b, passes through the indoor condenser 76b and the three-way valve 74a in a high-temperature and high-pressure state, is cooled into a liquid phase by heat exchange with outside air in an outdoor heat exchanger 71a, is sprayed to the evaporator 76a by an expansion valve 73a, and is vaporized. At this time, the refrigerant exchanges heat with air blown from a fan F. The heat-exchanged cold air is sent to the vehicle interior via a duct 77a communicating with the vehicle interior in a state in which a shutter 77c is separated by a partition wall 77b to open a cooling air passage 78a and to close a heating air passage 78b.

At the time of heating, the ON/OFF states of the three-way valve 74a and the ON/OFF valves 74b and 74c are controlled such that a refrigerant circulates as follows. As illustrated in FIG. 11B, a refrigerant in a gas phase is condensed by the air-conditioning compressor 71b and exchanges heat with air flown from the fan F in the indoor condenser 76b in a high-temperature and high-pressure state. The heat-exchanged warm air is sent to the vehicle interior in a state in which the shutter 77c closes the air passage 78a and opens the air passage 78b. The refrigerant liquefied by the indoor condenser 76b passes through the three-way valve 74a, is changed into a fog state by the expansion valve 73b, flows into the outdoor heat exchanger 71a, and exchanges heat with outside air at the time of being vaporized in the outdoor heat exchanger 71a. The vaporized refrigerant is condensed again by the air-conditioning compressor 71b.

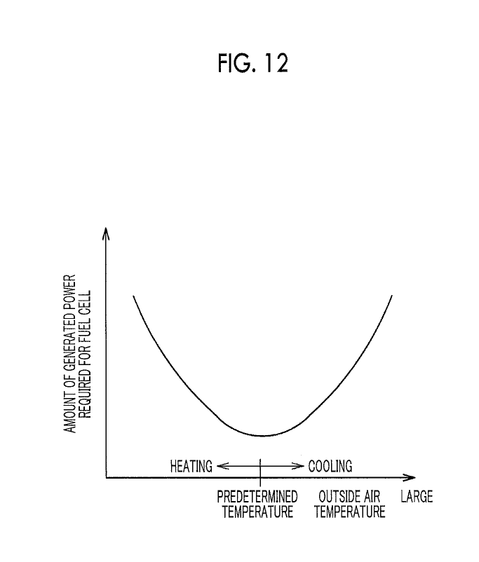

The control device 60 calculates a value, which is obtained by adding a required amount of generated power required for the fuel cell 20 by the air-conditioning system 70 to the required amount of generated power for the fuel cell 20 based on the gradient and the vehicle speed illustrated in FIG. 6A, as a predicted amount of generated power P of the fuel cell 20. The required amount of generated power required for the fuel cell 20 by the air-conditioning system 70 is estimated based on an outside air temperature. FIG. 12 illustrates a map in which a relationship between the required amount of generated power required for the fuel cell 20 by the air-conditioning system 70 and the outside air temperature is defined. This map is calculated by experiment in advance and is stored in the memory 64 of the control device 60. In this map, when the temperature of the vehicle interior is held at a predetermined temperature, for example, 25° C., the required amount of generated power required for the fuel cell 20 by the air-conditioning system 70, which varies depending on the outside air temperature, is defined. As a difference between the predetermined temperature and the outside air temperature increases, it is necessary to increase a flow rate of a refrigerant carried by the air-conditioning compressor 71b and the power consumption of the air-conditioning compressor 71b also increases. Accordingly, the required amount of generated power required for the fuel cell 20 also increases. The outside air temperature is acquired by the control device 60 using the outside air temperature sensor 84. In this way, when the predicted amount of generated power P of the fuel cell 20 is calculated, it is possible to more accurately calculate the predicted amount of generated power P of the fuel cell 20 based on the amount of generated power of the fuel cell 20 which is consumed by the air-conditioning system 70 in addition to the gradient and the average vehicle speed on the scheduled traveling route. The calculation of the predicted amount of generated power P based on the required amount of generated power required for the fuel cell 20 by the air-conditioning system 70 is performed only when the air-conditioning system 70 is activated, but is not performed when the air-conditioning system 70 is stopped.

The server 100 may calculate the predicted amount of generated power P based on the required amount of generated power required for the fuel cell 20 by the air-conditioning system 70. In this case, the map illustrated in FIG. 12 is stored in the HDD 104 of the server 100 for each vehicle type.

In the above-mentioned embodiment and the above-mentioned modified examples, the predicted amount of emitted heat Ph of the fuel cell 20 is calculated based on the gradient and the average vehicle speed, but may be calculated based on only the average vehicle speed. In a range in which a driver generally drives a vehicle, this is because a gradient of a road is often small or an average value of the gradient is often close to zero, and thus it is conceived that an influence of the vehicle speed predominates.

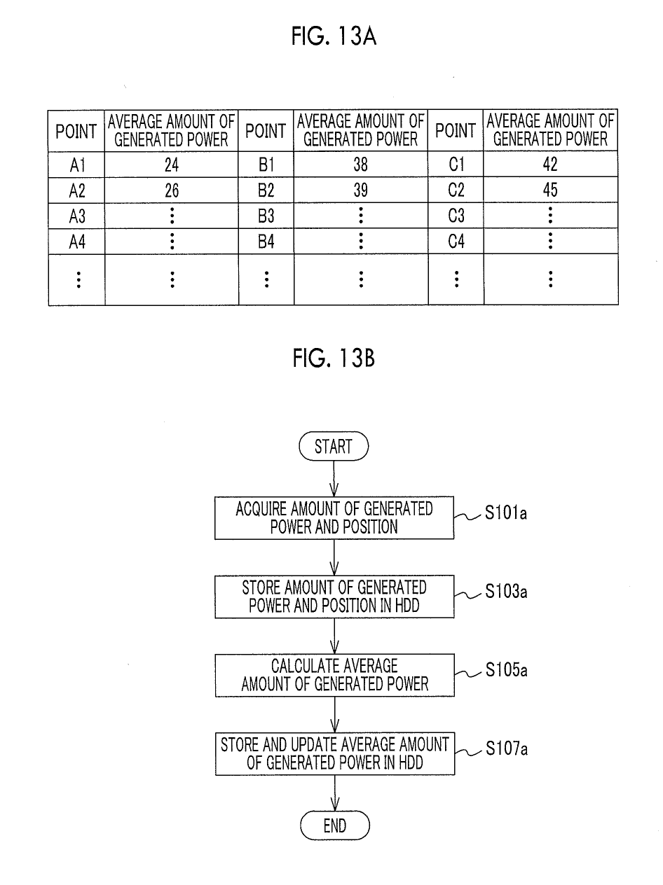

A third modified example will be described below. In the third modified example, the predicted amount of generated power P is calculated based on an average amount of generated power stored in the server 100 instead of the average vehicle speed. The predicted maximum cooling capability Pc is calculated based on a predicted vehicle speed such as the average vehicle speed stored in the server 100, similarly to the above-mentioned embodiment. The average amount of generated power is an example of the predicted amount of generated power of the fuel cell 20 of the vehicle 1. First, the average amount of generated power will be described. FIG. 13A is a diagram illustrating an example of the average amount of generated power stored in the HDD 104 of the server 100. In the HDD 104, the amounts of generated power of fuel cells of a fuel-cell vehicle group which is correlated with positional information of the fuel-cell vehicle group using a fuel cell as a traveling power source and the average amount of generated power of the fuel cells at each point are stored. Similarly to the above-mentioned embodiment, the average vehicle speed at each point is also stored in the HDD 104.

Control for calculating the average amount of generated power which is performed by the server 100 will be described below. FIG. 13B is a flowchart illustrating an example of the control for calculating an average amount of generated power. This control is repeatedly performed at predetermined intervals. First, current locations of a plurality of fuel-cell vehicles and amounts of generated power of fuel cells of the vehicles at the locations are acquired from the fuel-cell vehicles via the network N (Step S101a). Then, the acquired locations and the acquired amounts of generated power are stored in the HDD 104 in correlation with each other (Step S103a). Then, an average amount of generated power which is an average value of the amounts of generated power is calculated based on the amounts of generated power of the plurality of fuel cells acquired at the same point (Step S105a). The calculated average amount of generated power is stored and updated in the HDD 104 in correlation with the point (Step S107a). Accordingly, the average amount of generated power at each point is an average amount of generated power of the fuel-cell vehicle group including the vehicle 1 when the vehicle 1 has traveled through the point, and is an average amount of generated power of the fuel-cell vehicle group not including the vehicle 1 when the vehicle 1 has never traveled through the point. Accordingly, the average amount of generated power stored in the server 100 reflects at least one of the amount of generated power of the fuel cell 20 when the vehicle 1 traveled in the past and an amount of generated power of a fuel cell of a different vehicle when the different vehicle traveled in the past. Similarly to the above-mentioned embodiment, the server 100 also calculates the average vehicle speed at each point.

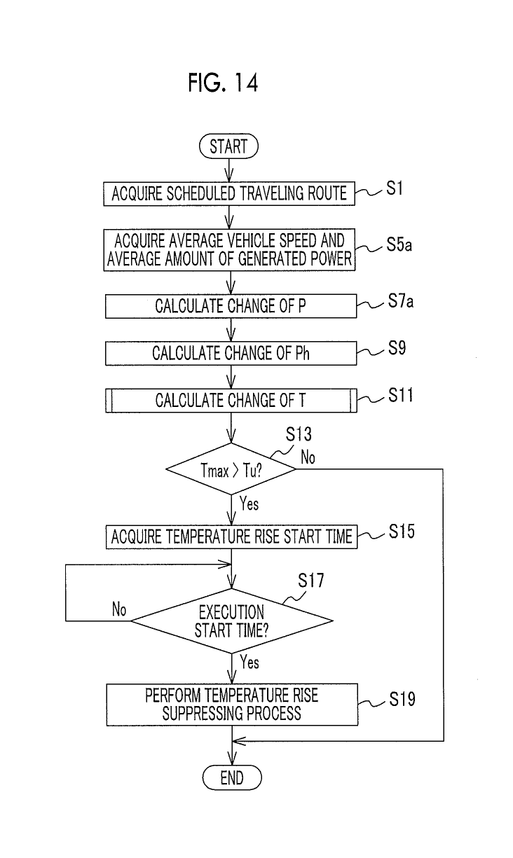

FIG. 14 is a flowchart illustrating an example of temperature control according to the third modified example. After a scheduled traveling route is acquired in Step S1, a gradient is not acquired but the average vehicle speed and the average amount of generated power at each point on the scheduled traveling route are acquired from the server 100 (Step S5a). The process of Step S5a is an example of a process which is performed by the acquisition unit.

Then, change of the predicted amount of generated power P is calculated based on the average amount of generated power at each point on the scheduled traveling route (Step S7a). Specifically, the average amount of generated power at each point is regarded as the predicted amount of generated power P. The predicted amount of emitted heat Ph is calculated with reference to the map illustrated in FIG. 6B based on the predicted amount of generated power P at each point calculated in this way. In this way, the reason for calculating the predicted amount of emitted heat Ph of the vehicle 1 based on the average amount of generated power of the fuel-cell vehicle group which has traveled on the scheduled traveling route is that it can be conceived that the vehicle 1 travels on the scheduled traveling route in conditions in which the amount of generated power of the fuel cell 20 of the vehicle 1 is close to the average amount of generated power. Accordingly, it is possible to accurately calculate the change of the predicted amount of emitted heat Ph. Since the predicted amount of generated power P is easily calculated based on the average amount of generated power stored in the server 100, it is possible to reduce a processing load of the control device 60.

The predicted amount of generated power P may be calculated based on the average amount of generated power of a fuel-cell vehicle group having the same vehicle type or model number as the vehicle 1 among the amounts of generated power stored in the server 100. Accordingly, it is possible to more accurately calculate the predicted amount of emitted heat Ph. In this case, the server 100 calculates the average amount of generated power for each vehicle type or each model number based on the identification information of the fuel-cell vehicles and the amounts of generated power of the fuel cells at each point which are transmitted from the fuel-cell vehicle group, and stores the calculated average amount of generated power in the HDD 104. The control device 60 acquires the average amount of generated power of the fuel cells having the same vehicle type or model number as the vehicle 1 with reference to the identification information of the vehicle 1 and the identification information stored in the HDD 104.

The predicted amount of generated power P may be calculated by correcting the average amount of generated power stored in the server 100 depending on the vehicle type of the vehicle 1. For example, when the vehicle 1 is a large-sized vehicle, the predicted amount of generated power P may be calculated based on a value which has been corrected to increase the average amount of generated power stored in the server 100. Accordingly, it is possible to accurately calculate the predicted amount of emitted heat Ph. In this case, the control device 60 may perform the correction or the server 100 may perform the correction.

In the third modified example, the control may be performed as follows similarly to the above-mentioned embodiment. The average amount of generated power acquired from the server 100 may be an average amount of generated power of a partial vehicle group sorted based on a predetermined criterion among all the fuel-cell vehicles. The previous average amount of generated power stored in the server 100 may be used. The predicted amount of generated power P may be calculated based on the average amount of generated power stored in the server 100, or may be calculated by correcting the average amount of generated power stored in the server 100, for example, based on a difference between the actual amount of generated power of the fuel cell 20 of the vehicle 1 in a predetermined traveling section and the average amount of generated power stored in the server 100. In the third modified example, the control device 60 sand the server 100 may perform the temperature control in cooperation with each other.

Without being limited to the average amount of generated power, the change of the predicted amount of generated power P may be calculated based on the amount of generated power of the fuel cell 20 when the vehicle 1 actually traveled on the scheduled traveling route in the past, which is stored in the server 100. Accordingly, it is possible to accurately calculate the change of the predicted amount of emitted heat Ph. In this case, the server 100 stores identification information and positions of the vehicles and the amounts of generated power of the fuel cells of the vehicles in the HDD 104 from time to time. The control device 60 acquires the amount of generated power of the fuel cell 20 when the vehicle 1 traveled on the scheduled traveling route in the past from the HDD 104 with reference to the identification information of the vehicle 1 and the identification information stored in the HDD 104 and calculates the predicted amount of generated power P. The amount of generated power of the fuel cell 20 in the same time zone at each point on the scheduled traveling route on which the vehicle 1 has traveled may be used. In this case, the server 100 stores the identification information, and the position, and the amount of generated power of the fuel cell, which are transmitted from each vehicle and the date and time in the HDD 104 in correlation with each other from time to time.

When the average amount of generated power at a certain point on the scheduled traveling route which is stored in the server 100 is based on only the amount of generated power of a fuel cell of a single vehicle, the predicted amount of generated power P of the vehicle 1 is calculated based on the amount of generated power of the fuel cell of the single vehicle. In this case, the amount of generated power stored in the server 100 may be an amount of generated power of the fuel cell 20 when the vehicle 1 traveled on the scheduled traveling route in the past or may be an amount of generated power of a fuel cell when the different vehicle traveled on the scheduled traveling route in the past.

In the third modified example, the predicted amount of emitted heat Ph may be calculated in same way as in the second modified example. For example, when the average amount of generated power acquired by the control device 60 is data which has been calculated, for example, at a certain past time in one hour from the present time, the outside air temperature at the present time can be regarded to be substantially the same as the outside air temperature at the time point at which the average amount of generated power is calculated. Accordingly, since the required amount of generated power required by the air-conditioning system 70 at the present time is substantially the same as the required amount of generated power required by the air-conditioning system 70 when the average amount of generated power was calculated, the predicted amount of emitted heat Ph may be calculated without correcting the acquired average amount of generated power. On the other hand, when the average amount of generated power acquired by the control device 60 is data which has been updated, for example, in several hours from the present time to the past, there is a likelihood that the outside air temperature at the present time will be different from the outside air temperature at the time point at which the average amount of generated power was calculated and the required amount of generated power required by the air-conditioning system 70 will vary. In this case, the predicted amount of generated power P may be calculated by calculating the required amount of generated power required by the air-conditioning system 70 from the outside air temperature at the time at which the average amount of generated power was calculated and the current outside air temperature at the present time using the map illustrated in FIG. 12 and adding or subtracting the difference therebetween to or from the average amount of generated power.

While exemplary embodiments of the present disclosure have been described above in detail, the present disclosure is not limited to any specific embodiment, but can be modified in various forms without departing from the gist of the present disclosure described in the appended claims.

What is claimed is:

1. A monitoring device of a fuel cell, comprising:
an acquisition unit configured to acquire a predicted vehicle speed of a vehicle at each point on a scheduled traveling route of the vehicle which travels using the fuel cell as a power source, a temperature of a refrigerant that receives heat from the fuel cell, and a temperature of air outside the vehicle to which the refrigerant exposed to a traveling airflow of the vehicle radiates heat; and
a calculation unit configured to calculate a predicted temperature of the refrigerant at a first point on the scheduled traveling route based on the predicted vehicle speed at the first point, the temperature of the refrigerant, and the temperature of the outside air and to calculate the predicted temperature at a second point subsequent to the first point on the scheduled traveling route based on the predicted vehicle speed at the second point, the calculated predicted temperature at the first point, and the temperature of the outside air.

2. The monitoring device of a fuel cell according to claim 1, wherein the acquisition unit additionally acquires a gradient at each point on the scheduled traveling route, and
the calculation unit calculates the predicted temperature at the first point based on the predicted vehicle speed and the gradient at the first point, the temperature of the refrigerant, and the temperature of the outside air and calculates the predicted temperature at the second point based on the predicted vehicle speed and the gradient at the second point, the calculated predicted temperature at the first point, and the temperature of the outside air.

3. The monitoring device of a fuel cell according to claim 2, wherein the predicted vehicle speed is calculated based on an average vehicle speed which is an average value of traveling speeds of a vehicle group having traveled on the scheduled traveling route.

4. The monitoring device of a fuel cell according to claim 1, wherein the calculation unit calculates the predicted temperatures at the first and second points based on a state of an air-conditioning device of the vehicle which is driven by the fuel cell.

5. The monitoring device of a fuel cell according to claim 1, wherein the acquisition unit acquires the predicted vehicle speed from a server which is disposed outside the vehicle by radio communication.

6. The monitoring device of a fuel cell according to claim 1, further comprising:
a result acquiring unit configured to acquire the predicted temperature calculated by the calculation unit and a determination result indicating that a maximum value of the calculated predicted temperatures is higher than a threshold value; and
a temperature rise suppression control unit configured to start a temperature rise suppressing process of suppressing a temperature rise of the fuel cell before a temperature rise start time at which the predicted temperature starts increasing to the maximum value when the predicted temperature and the determination result are acquired.

7. The monitoring device of a fuel cell according to claim 6, wherein the temperature rise suppressing process includes at least one of a process of decreasing a target temperature of the refrigerant, a process of increasing a back pressure on a cathode side of the fuel cell, and a process of increasing a target state of charge of a secondary battery that complements an amount of generated power of the fuel cell in comparison with a case in which the temperature rise suppressing process is not performed.

8. A monitoring device of a fuel cell, comprising:
an acquisition unit configured to acquire a predicted vehicle speed of a vehicle at each point on a scheduled traveling route of the vehicle which travels using the fuel cell as a power source, a predicted amount of generated power of the fuel cell at each point on the scheduled traveling route, a temperature of a refrigerant that receives heat from the fuel cell, and a temperature of air outside the vehicle to which the refrigerant exposed to a traveling airflow of the vehicle radiates heat; and
a calculation unit configured to calculate a predicted temperature of the refrigerant at a first point on the scheduled traveling route based on the predicted vehicle speed and the predicted amount of generated power at the first point, the temperature of the refrigerant, and the temperature of the outside air and to calculate the predicted temperature at a second point subsequent to the first point on the scheduled traveling route based on the predicted vehicle speed and the predicted amount of generated power at the second point, the calculated predicted temperature at the first point, and the temperature of the outside air.

9. The monitoring device of a fuel cell according to claim 8, wherein the predicted amount of generated power is calculated based on at least one of an amount of generated power of the fuel cell on the scheduled traveling route when the vehicle traveled on the scheduled traveling route and an amount of generated power of a different fuel cell mounted as a power source for traveling in a different vehicle when the different vehicle traveled on the scheduled traveling route.

10. The monitoring device of a fuel cell according to claim 8, wherein the calculation unit calculates the predicted temperatures at the first and second points based on a state of an air-conditioning device of the vehicle which is driven by the fuel cell.

11. The monitoring device of a fuel cell according to claim 8, wherein the acquisition unit acquires the predicted vehicle speed from a server which is disposed outside the vehicle by radio communication.

12. The monitoring device of a fuel cell according to claim 8, wherein the acquisition unit acquires the predicted amount of generated power from a server which is disposed outside the vehicle by radio communication.

13. The monitoring device of a fuel cell according to claim 8, further comprising:
a result acquiring unit configured to acquire the predicted temperature calculated by the calculation unit and a determination result indicating that a maximum value of the calculated predicted temperatures is higher than a threshold value; and
a temperature rise suppression control unit configured to start a temperature rise suppressing process of suppressing a temperature rise of the fuel cell before a temperature rise start time at which the predicted temperature starts increasing to the maximum value when the predicted temperature and the determination result are acquired.

14. The monitoring device of a fuel cell according to claim 13, wherein the temperature rise suppressing process includes at least one of a process of decreasing a target temperature of the refrigerant, a process of increasing a back pressure on a cathode side of the fuel cell, and a process of increasing a target state of charge of a secondary battery that complements an amount of generated power of the fuel cell in comparison with a case in which the temperature rise suppressing process is not performed.

15. A monitoring method of a fuel cell, comprising:
acquiring, as an acquisition step, a predicted vehicle speed of a vehicle at each point on a scheduled traveling route of the vehicle which travels using the fuel cell as a power source, a temperature of a refrigerant that receives heat from the fuel cell, and a temperature of air outside the vehicle to which the refrigerant exposed to a traveling airflow of the vehicle radiates heat; and
calculating, as a calculation step, a predicted temperature of the refrigerant at a first point on the scheduled traveling route based on the predicted vehicle speed at the first point, the temperature of the refrigerant, and the temperature of the outside air and calculating the predicted temperature at a second point subsequent to the first point on the scheduled traveling route based on the predicted vehicle speed at the second point, the calculated predicted temperature at the first point, and the temperature of the outside air.

16. A monitoring method of a fuel cell, comprising:
acquiring, as an acquisition step, a predicted vehicle speed of a vehicle at each point on a scheduled traveling route of the vehicle which travels using the fuel cell as a power source, a predicted amount of generated power of the fuel cell at each point on the scheduled traveling route, a temperature of a refrigerant that receives heat from the fuel cell, and a temperature of air outside the vehicle to which the refrigerant exposed to a traveling airflow of the vehicle radiates heat; and
calculating, as a calculation step, a predicted temperature of the refrigerant at a first point on the scheduled traveling route based on the predicted vehicle speed and the predicted amount of generated power at the first point, the temperature of the refrigerant, and the temperature of the outside air and calculating the predicted temperature at a second point subsequent to the first point on the scheduled traveling route based on the predicted vehicle speed and the predicted amount of generated power at the second point, the calculated predicted temperature at the first point, and the temperature of the outside air.
